(19) United States
(12) Patent Application Publication
(10) Pub. No.: US 2011/0076430 A1
(43) Pub. Date: Mar. 31, 2011

(54) Pressure-sensitive adhesive sheet and disposable body warmer

(75) Inventor: Yoshitake Shigematsu, Matsuyama-shi (JP)

(73) Assignee: NITTO LIFETEC CORPORATION, Matsuyama-shi (JP)

(21) Appl. No.: 12/923,516

(22) Filed: Sep. 24, 2010

(30) Foreign Application Priority Data
Sep. 29, 2009 (JP) 2009-224702

(51) Int. Cl. C09J 7/02; B32B 27/00; B32B 5/18

(52) U.S. Cl. 428/35.2; 428/313.5

(57) ABSTRACT

This invention provides a pressure-sensitive adhesive sheet having a base material and a pressure-sensitive adhesive layer containing a urethane resin or a styrene copolymer and also containing hollow microspheres and bubbles, formed at least on one side of the base material. This invention also provides a disposable body warmer having the pressure-sensitive adhesive sheet as a bag-constituting component.

### TECHNICAL FIELD

The present invention relates to a pressure-sensitive adhesive sheet. More specifically, it relates to a pressure-sensitive adhesive sheet, that can be produced at low cost and of which the foam structure of the pressure-sensitive adhesive layer (bubbles and hollow microspheres) are resistant to destruction even when pressurized, in particular, that is suitable for a dispensable body warmer. It also relates to a disposable body warmer containing the pressure-sensitive adhesive sheet.

### BACKGROUND ART

Pressure-sensitive adhesive sheets having a pressure-sensitive adhesive layer containing bubbles (inert gas) have been used in various fields and, for example, pressure-sensitive adhesive sheets for adhesion of a disposable body warmer or the like to the body (pressure-sensitive adhesive sheets for body warmer) are known from the viewpoints of elasticity, flexibility (softness) and adhesiveness. For example, a patch having a pressure-sensitive adhesive layer made of an adhesive foam containing bubbles of nitrogen or carbon dioxide gas is known (see Patent Document 1).

However, the pressure-sensitive adhesive layer described in Patent Document 1 had a problem that the bubbles are broken when pressurized during use and thus, the properties of the patch such as elasticity, flexibility and adhesiveness decline over time.

In addition, in the case of a pressure-sensitive adhesive sheet having a pressure-sensitive adhesive layer, which is prepared by using a styrene copolymer such as styrene-isoprene-styrene (SIS) copolymer as the base polymer, on a nonwoven fabric base material, there was a problem that the adhesive impregnates into the nonwoven fabric base material by the pressure during heat sealing.

### [Citation List]

### [Patent Literature]

Patent Document 1 Japanese Unexamined Patent Application Publication (JP-A) No. 08-92075

### SUMMARY OF INVENTION

### Technical Problem

Accordingly, an object of the present invention is to provide a pressure-sensitive adhesive sheet that can be produced at low cost and of which the foam structure of the pressure-sensitive adhesive layer (bubbles and hollow microspheres) is resistant to destruction even when pressurized. Another object is to provide a disposable body warmer containing the pressure-sensitive adhesive sheet, which is a pressure-sensitive adhesive sheet for body warmer.

### [Solution to Problem]

After intensive studies to solve the problems above, the inventor has found that it is possible to obtain a pressure-sensitive adhesive sheet that can be produced at low cost and of which the foam structure of the pressure-sensitive adhesive layer is resistant to destruction even when pressurized, by forming a pressure-sensitive adhesive layer containing a urethane resin or a styrene copolymer, hollow microspheres and bubbles at least on one side of a base material, and made the present invention.

Specifically, the present invention provides a pressure-sensitive adhesive sheet which includes a base material and a pressure-sensitive adhesive layer. The pressure-sensitive adhesive layer contains a urethane resin or a styrene copolymer and also contains hollow microspheres and bubbles. The pressure-sensitive adhesive layer is formed at least on one side of the base material.

The pressure-sensitive adhesive sheet may be a pressure-sensitive adhesive sheet for body warmer.

In the pressure-sensitive adhesive sheet, the hollow microspheres may be hollow microspheres formed by expansion of heat-expandable microspheres.

The present invention further provides a disposable body warmer which includes the pressure-sensitive adhesive sheet as a bag-constituting component.

### Advantageous Effects of Invention

The pressure-sensitive adhesive sheet of the present invention, which employs a urethane resin or a styrene copolymer as the base polymer for the pressure-sensitive adhesive layer, has favorable adhesion properties, in particular favorable adhesion properties suitable for the disposable body warmer application. Because the pressure-sensitive adhesive layer contains both bubbles and hollow microspheres, the foam structure of the pressure-sensitive adhesive layer is resistant to destruction even when the pressure-sensitive adhesive layer is pressurized and the adhesive sheet retains its favorable elasticity, flexibility and adhesiveness to the adherent. In addition, the pressure-sensitive adhesive sheet can also be produced at lower cost, compared to the case when only hollow microspheres are used.

Even when a styrene copolymer is used as the base polymer for the pressure-sensitive adhesive layer, it is possible to reduce impregnation of the adhesive into the nonwoven fabric base material during heat sealing, because of the influence by the foam structure.

### BRIEF DESCRIPTION OF DRAWINGS

FIG. 1 is a schematic cross-sectional view illustrating an example of the pressure-sensitive adhesive sheet of the present invention.

FIG. 2 is a schematic cross-sectional view illustrating an example of the disposable body warmer of the present invention.

### DESCRIPTION OF EMBODIMENTS

The pressure-sensitive adhesive sheet of the present invention has a pressure-sensitive adhesive layer containing a urethane resin or a styrene copolymer and also containing hollow microspheres and bubbles at least on one side of a base material. The essential pressure-sensitive adhesive layer, i.e., the “pressure-sensitive adhesive layer containing a urethane resin or a styrene copolymer and also containing hollow microspheres and bubbles,” may be referred to as the “pressure-sensitive adhesive layer of the present invention”. In the present description, the “pressure-sensitive adhesive sheet” includes sheet-shaped products and also tape-shaped products, i.e., “adhesive tapes”.

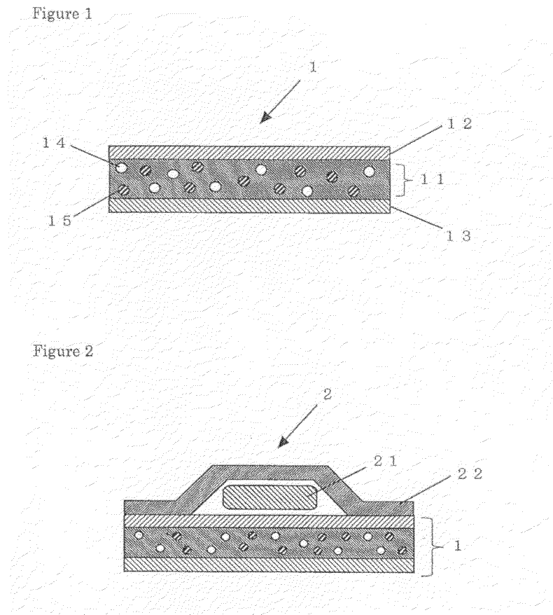

FIG. 1 is a schematic cross-sectional view illustrating an example of the pressure-sensitive adhesive sheet of the present invention. The pressure-sensitive adhesive sheet of the present invention 1 shown in FIG. 1 has a base material 12 and a pressure-sensitive adhesive layer 11 of the present invention formed (arranged) on one side of the base material 12. The pressure-sensitive adhesive layer 11 of the present invention contains bubbles 14 and hollow microspheres 15. A release liner 13 (also called separator or release film) may be formed on the surface of the pressure-sensitive adhesive layer 11 of the present invention opposite to the base material 12, for protection of the pressure-sensitive adhesive layer surface (adhesive face) before use. The release liner 13 is separated before the adhesive face protected by the release liner 13 is used (i.e., when the pressure-sensitive adhesive sheet 1 is adhered to an adherent).

Application of the pressure-sensitive adhesive sheet of the present invention is not particularly limited, and examples thereof include pressure-sensitive adhesive sheets for body warmer, pressure-sensitive adhesive sheets for temporary fixation, industrial pressure-sensitive adhesive sheets and the like. In particular, the pressure-sensitive adhesive sheet of the present invention is used favorably as a pressure-sensitive adhesive sheet for body warmer. More specifically, it is used favorably, for example, in application as a component (bag-constituting component) constituting a bag for storing a heating unit for disposable body warmer (hereinafter, referred to simply as “bag”), in particular in application as a bag-constituting component on the bonding (affixing) face side of disposable body warmer to which an adherent (such as clothes and skin) is bonded (affixed). In particular, because the pressure-sensitive adhesive sheet is superior in the impression of use and adhesiveness, it is used favorably in the application of body warmer bonded (affixed) directly to the skin (direct adhesion application).

### [Base Material]

The base material (substrate) in the pressure-sensitive adhesive sheet of the present invention is not particularly limited, and examples thereof favorably used include thin-film products including paper base materials such as paper; fibrous base materials such as woven fabrics, nonwoven fabrics and nets; metal base materials such as metal foils and metal plates; plastic base materials such as plastic films and sheets (include porous films); rubber base materials such as rubber sheets; foamed base materials such as foam sheets; laminates thereof (such as laminate films of a plastic base material and another base material and those of plastic films (or sheets)) and the like. In particular, plastic base materials (in particular, plastic films and sheets) and fibrous base materials (in particular, nonwoven fabrics) are preferable.

The base material may be non-porous or porous. When the pressure-sensitive adhesive layer of the pressure-sensitive adhesive sheet of the present invention is formed by curing with active energy ray, the base material for use is preferably a material not inhibiting transmission of the active energy ray.

The thickness of the base material is not particularly limited, but preferably, for example 1000 μm or less (e.g., 1 to 1000 μm), more preferably 1 to 500 μm and still more preferably 3 to 300 μm. The base material may have a single-layer shape or a laminated shape.

Examples of the raw materials for the plastic base materials (in particular, plastic films and sheets) include polyolefin resins containing an α-olefin as its monomer component, such as polyethylenes (PEs), polypropylenes (PPs), ethylene-propylene copolymers and ethylene vinyl acetate copolymers (EVAs); polyester resins such as polyethylene terephthalates (PETs), polyethylene naphthalates (PENs) and polybutylene terephthalates (PBTs); polyvinyl chlorides (PVCs); vinyl acetate resins; polyphenylene sulfides (PPSs); poly-amide resins such as polyamides (nylons) and wholly aromatic polyamides (aramids); polyimide resins; polyether ether ketones (PEEKs) and the like. These raw materials may be used alone or in combination of two or more. As the plastic base materials, polyester films and polyolefin films (in particular, polypropylene films) are preferable, and particularly preferable are PET films (non-porous).

The nonwoven fabric is not particularly limited, and examples thereof for use include known and commonly used nonwoven fabrics (such as nonwoven fabrics of natural fibers and nonwoven fabrics of synthetic fibers) including polyamide nonwoven fabrics (such as nylon nonwoven fabrics), polyester nonwoven fabrics (such as polyethylene terephthalate (PET) nonwoven fabrics and polybutylene terephthalate (PBT) nonwoven fabrics), polyolefin nonwoven fabrics and rayon nonwoven fabrics. The nonwoven fabric may contain fibers of one type alone or contain fibers of two or more types in combination.

The production method for the nonwoven fabric is also not particularly limited, and the nonwoven fabric may be, for example, a nonwoven fabric produced by spunbonding (spunbonded nonwoven fabric) or a nonwoven fabric produced by spunlacing (spunlaced nonwoven fabric). The nonwoven fabric may have a single-layer shape or a laminate shape. The fiber diameter, the fiber length and the basis weight (mass per unit area) of the nonwoven fabric are not particularly limited. The basis weight is preferably 20 to 100 g/m², more preferably 20 to 80 g/m².

### [Pressure-Sensitive Adhesive Layer of the Present Invention]

The pressure-sensitive adhesive layer of the present invention (a pressure-sensitive adhesive layer containing a urethane resin or a styrene copolymer and also containing hollow microspheres and bubbles) in the pressure-sensitive adhesive sheet of the present invention contains a urethane resin or a styrene copolymer (at least one polymer selected from the group consisting of urethane resins and styrene copolymers) and hollow microspheres and bubbles as essential components. Thus, the pressure-sensitive adhesive layer of the present invention is a urethane-based pressure-sensitive adhesive layer containing a urethane resin as its base polymer (pressure-sensitive adhesive layer containing a urethane resin, bubbles and hollow microspheres as essential components) or a styrene-based pressure-sensitive adhesive layer containing a styrene copolymer as its base polymer (pressure-sensitive adhesive layer containing a styrene copolymer, bubbles and hollow microspheres as essential components).

The “hollow microsphere”, as used in the present description, means a sphere in the structure containing a gas component in the shell (sheath, casing). The “bubble” represents, in particular, a structure only made of a gas component without shell, i.e., a shell-free gas component (bubble) present in the pressure-sensitive adhesive layer. The “hollow microsphere” and the “bubble” may be called “foam structure” combinedly.

### (Urethane Resin)

The urethane resin is not particularly limited and may be any one of known and commonly used urethane resins for urethane-based pressure-sensitive adhesives (urethane pressure-sensitive adhesives). Examples of the urethane resins for use include urethane resins prepared from one or more polyisocyanate compounds and one or more polyol compounds. The urethane resins may be used alone or in combination of two or more.

Examples of the polyisocyanate compounds include aliphatic polyisocyanates, alicyclic polyisocyanates, aromatic polyisocyanates, araliphatic polyisocyanates and the like. The polyisocyanate compounds may be used alone or in combination of two or more.

Examples of the aliphatic polyisocyanates include 1,6-hexamethylene diisocyanate, 1,4-tetramethylene diisocyanate, 2-methyl-1,5-pentane diisocyanate, 3-methyl-1,5-pentane diisocyanate, lysine diisocyanate, 2,4,4-trimethyl-1,6-hexamethylene diisocyanate, 2,2,4-trimethyl-1,6-hexamethylene diisocyanate and the like. Examples of the alicyclic polyisocyanates include isophorone diisocyanate, norbornane diisocyanate, cyclohexyl diisocyanate, hydrogenated tolylene diisocyanates, hydrogenated xylene diisocyanates, hydrogenated diphenylmethane diisocyanates, hydrogenated tetramethylxylene diisocyanates and the like. Examples of the aromatic polyisocyanates include 2,4-tolylene diisocyanate, 2,6-tolylene diisocyanate, 4,4′-diphenylmethane diisocyanate, 2,4′-diphenylmethane diisocyanate, 4,4′-diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate and the like. Examples of the araliphatic polyisocyanates include xylylene-1,4-diisocyanate, xylylene-1,3-diisocyanate and the like.

The polyisocyanate compound for use may be a dimer, trimer, reaction product or polymer of the aliphatic polyisocyanate, alicyclic polyisocyanate, aromatic polyisocyanate or araliphatic polyisocyanate above (such as dimer or trimer of diphenylmethane diisocyanate, reaction product of trimethylolpropane and tolylene diisocyanate, reaction product of trimethylolpropane and hexamethylene diisocyanate, polymethylene polyphenyl isocyanate, polyether polyisocyanate, polyester polyisocyanate or the like).

The polyol compound for use is not particularly limited, and may, for example, be any polyol compound used as a monomer component for known urethane polymers. Typical examples thereof include low-molecular weight polyol compounds such as polyvalent alcohols, high-molecular weight polyol compounds such as polyester polyols, polyether polyols, polycarbonate polyols, polyolefin polyols and polyacryl polyols, and the like. The polyol compounds may be used alone or in combination of two or more.

Examples of the polyvalent alcohols include diols such as ethylene glycol, diethylene glycol, propylene glycol, dipropylene glycol, 1,3-propanediol, 1,4-butanediol, 1,5-pentanediol, neopentylglycol, 1,6-hexanediol, 1,4-cyclohexanediol, bisphenol A, as well as glycerol, trimethylolpropane, trimethylolethane, sugar alcohols (xylitol, sorbitol, etc.) and the like.

The polyester polyol is not particularly limited, if it is a polyester polymer having at least two hydroxyl groups in the molecule (particularly preferably at terminals). The polyester polyol is prepared, for example, by a polymerization method of polymerizing a polyvalent alcohol with a polyvalent carboxylic acid by polycondensation, a ring-opening polymerization method of polymerizing a cyclic ester (lactone), or a combination thereof. A known condition may be used as needed as the polymerization condition for preparation of the polyester polyol. The polyvalent alcohol can be selected properly from the polyvalent alcohols exemplified above and dimer diols. For example, the polyvalent carboxylic acids can be selected from aliphatic dicarboxylic acids such as malonic acid, succinic acid, glutaric acid, adipic acid, pimelic acid, suberic acid, azelaic acid, sebacic acid, undecanedicarboxylic acid, dodecanedicarboxylic acid, tridecanedicarboxylic acid, tetradecanedicarboxlyic acid, pentadecanedicarboxylic acid, hexadecanedicarboxylic acid, heptadecanedicarboxylic acid, octadecanedicarboxylic acid and hexatriacontanedicarboxylic acid and dimer acids; alicyclic dicarboxylic acids such as 1,4-cyclohexanedicarboxylic acid; aromatic dicarboxylic acids such as terephthalic acid, isophthalic acid and phthalic acid; and the like. Examples of the cyclic esters include ε-caprolactone and the like. Typical examples of the polyester polyols include polyester polyols from a dimer acid and 1,6-hexamethylene diol, polyester polyols from hexatriacontanedicarboxylic acid and a dimer diol, polyester polyols from a dimer acid and a dimer diol, and the like.

The polyether polyol is not particularly limited, if it is a polyether polymer having at least two hydroxyl groups in the molecule (particularly preferably at terminals). The polyether polyol is prepared, for example, a polymerization method of polymerizing an alkylene glycol by condensation, a ring opening polymerization method of polymerizing a cyclic ether, or a method in combination thereof. A known condition may be used as needed as the polymerization condition for preparation of the polyether polyol.

Examples of the alkylene glycols include ethylene glycol, propylene glycol, tetramethylene glycol and the like. Typical examples of the polyether polyols include polyalkylene glycols such as polyethylene glycol, polypropylene glycol, polytetramethylene glycol and poly(ethylene glycol-propylene glycol) copolymers and the like.

The polycarbonate polyol is not particularly limited, if it is a polycarbonate polymer having at least two hydroxyl groups in the molecule (particularly preferably at terminals). The polycarbonate polyol can be prepared for example by a method of reacting a polyvalent alcohol with phosgene, a method of reacting a polyvalent alcohol with a diphenyl carbonate by ester exchange, a ring-opening polymerization method of polymerizing a cyclic carbonate eater (e.g., alkylene carbonate such as ethylene carbonate, trimethylene carbonate, tetramethylene carbonate or hexamethylene carbonate), or a method in combination thereof.

The polyolefin polyol or the polyacrylpolyol is not particularly limited, if it is an olefinic polymer having at least two hydroxyl groups in the molecule (particularly preferably at terminals) or an acrylic polymer having at least two hydroxyl groups in the molecule (particularly preferably at terminals). For introduction of hydroxyl groups into the olefinic polymer or the acrylic polymer, a hydroxyl group-containing α,β-unsaturated compound [e.g., hydroxyalkyl(meth)acrylate ester such as 2-hydroxyethyl(meth)acrylate or 3-hydroxypropyl(meth)acrylate] is used as the copolymerization component for the olefin of the principal monomer component of the olefinic polymer or for the (meth)acrylic ester of the principal monomer component of the acrylic polymer.

The urethane resin may be a urethane resin prepared from a urethane prepolymer by polymerization with active energy ray (photopolymerization) using a polymerization initiator (photopolymerization initiator). The urethane prepolymer is prepared from a urethane polymer composed of the polyisocyanate compound(s) and the polyol compound(s), with a reactive functional group introduced, and may be referred to as “reactive functional group-containing urethane-prepolymer”. In other words, the urethane resin may be an active energy ray-curing urethane resin prepared from a reactive functional group-containing urethane-prepolymer and a photopolymerization initiator. In particular, an ultraviolet ray (UV)-curing urethane resin is preferred. Examples of the reactive functional groups include vinyl group-containing reactive functional groups such as vinyl group, vinyl-alkyl groups (for example, allyl group), acryloyl group, and methacryloyl group; carboxyl group; hydroxyl group; epoxy group; amino group and the like. In particular, the reactive functional group is preferably a vinyl group-containing reactive functional group (reactive functional group containing a vinyl group), more preferably an acryloyl group or a methacryloyl group.

Examples of the urethane resins for use include the urethane-based pressure-sensitive adhesives and the urethane resins prepaked from the urethane prepolymers exemplified in Japanese Patent No. 3860880 and JP-A No. 2006-288690, and the like.

The polymerization initiator (photopolymerization initiator) used when the urethane resin is formed by active energy ray polymerization (photopolymerization) is not particularly limited, and examples thereof include benzoin ether photopolymerization initiators, acetophenone photopolymerization initiators, α-ketol photopolymerization initiators, aromatic sulfonyl chloride photopolymerization initiators, photoactive oxime photopolymerization initiators, benzoin photopolymerization initiators, benzyl photopolymerization initiators, benzophenone photopolymerization initiators, ketal photopolymerization initiators, thioxanthone photopolymerization initiators and the like. Examples of the benzoin ether photopolymerization initiators include benzoin methyl ether, benzoin ethyl ether, benzoin propyl ether, benzoin isopropyl ether, benzoin isobutyl ether, 2,2-dimethoxy-1,2-diphenyl ethan-1-one, anisole methyl ether and the like. Examples of the acetophenone photopolymerization initiators include 2,2-diethoxyacetophenone, 2,2-dimethoxy-2-phenylacetophenone, 1-hydroxycyclohexylphenylketone, 4-phenoxydichloroacetophenone, 4-(t-butyl)dichloroacetophenone and the like. Examples of the α-ketol photopolymerization initiators include 2-methyl-2-hydroxypropiophenone, 1-[4-(2-hydroxyethyl)phenyl]-2-methylpropan-1-one and the like. Examples of the aromatic sulfonyl chloride photopolymerization initiators include 2-naphthalene sulfonyl chloride and the like. Examples of the photoactive oxime photopolymerization initiators include 1-phenyl-1,1-propandione-2-(o-ethoxycarbonyl)-oxime and the like. Examples of the benzoin photopolymerization initiators include benzoin and the like. Examples of the benzyl photopolymerization initiators include benzyl and the like. Examples of the benzophenone photopolymerization initiators include benzophenone, benzoylbenzoic acid, 3,3′-dimethyl-4-methoxybenzophenone, polyvinylbenzophenone, α-hydroxycyclohexyl phenyl ketone and the like. Examples of the ketal photopolymerization initiators include benzyl dimethyl ketal and the like. Examples of the thioxanthone photopolymerization initiators include thioxanthone, 2-chlorothioxanthone, 2-methylthioxanthone, 2,4-dimethylthioxanthone, isopropylthioxanthone, 2,4-diisopropylthioxanthone, dodecylthioxanthone and the like.

The active energy ray used when the urethane resin is formed by active energy ray polymerilation (photopolymerization) is not particularly limited and examples thereof include ionizing radiation rays such as α ray, β ray, γ ray, neutron beam and electron beam, ultraviolet ray and the like, and ultraviolet ray is particularly favorable. The irradiation energy, the exposure period and others of the active energy ray are not particularly limited, if the active energy ray can activate the photopolymerization initiator, causing the reaction of the monomer component or the prepolymer.

Commercial products of the urethane resins or urethane prepolymers for preparation of the urethane resins described above can also be used, and an example thereof is “LIGHT TACK PSA-7511” (trade name, urethane prepolymer, manufactured by Kyoeisha Chemical Co., Ltd).

When the pressure-sensitive adhesive layer of the present invention is a urethane-based pressure-sensitive adhesive layer containing a urethane resin as its base polymer, the content of the urethane resin in the pressure-sensitive adhesive layer of the present invention is preferably 40 to 99 percent by weight (wt %), more preferably 60 to 99 wt % and still more preferably 70 to 99 wt %, with respect to the total amount (100 wt %) of the pressure-sensitive adhesive layer. The urethane resin content of less than 40 wt % may lead to easy release of the bubble-forming gas component after preparation of the pressure-sensitive adhesive sheet, when pressure is applied to the pressure-sensitive adhesive layer, and also to increase in the bubble size gradually over time, leading to disappearance of the bubble-forming gas component. It may also lead to deterioration in adhesion properties and possibly to residual of the adhesive on the adherent.

### (Styrene Copolymer)

The styrene copolymer is not particularly limited, if it is a copolymer prepared from monomer components including styrene, and any one of known, commonly-used styrene copolymers such as the styrenic elastomers used in styrenic pressure-sensitive adhesives may be used. Examples of the styrene copolymers include styrene-butadiene copolymers (SB), styrene-isoprene copolymers (SI), styrene-isoprene-styrene block copolymers (SIS), styrene-butadiene-styrene block copolymers (SBS), styrene-ethylene-butylene-styrene block copolymers (SEBS), styrene-ethylene-propylene-styrene block copolymers (SEPS), styrene-isoprene-propylene-styrene block copolymers (SIPS), styrene-ethylene-propylene block copolymers (SEP) and the like. In particular, the styrene copolymer is preferably a styrenic block copolymer, more preferably a SIS or SBS block copolymer, particularly preferably a SIS block copolymer, for providing adhesive properties suitable for disposable body warmer application. The styrene copolymers may be used alone or in combination of two or more.

The content of the styrene unit (structural unit derived from monomer styrene) in the styrene copolymer is preferably 5 to 40 wt %, more preferably 10 to 30 wt %. A styrene unit content of less than 6 wt % may lead to deterioration in cohesive force of the pressure-sensitive adhesive layer and thus to residual of the adhesive. A styrene unit content of more than 40 wt % may lead to insufficient adhesiveness (tackiness) of the pressure-sensitive adhesive layer.

Commercial products can also be used as the styrene copolymer, and examples thereof include, but are not particularly limited to, “Quintac 3433N” (trade name, SIS copolymer, manufactured by Zeon Corporation) and the like.

When the pressure-sensitive adhesive layer of the present invention is a styrene-based pressure-sensitive adhesive layer containing a styrene copolymer as the base polymer, the content of the styrene copolymer in the pressure-sensitive adhesive layer of the present invention is preferably 10 to 99 wt %, more preferably 50 to 80 wt %, with respect to the total amount (100 wt %) of the pressure-sensitive adhesive layer. The styrene copolymer content of less than 10 wt % may lead to easy release of the bubble-forming gas component after preparation of the pressure-sensitive adhesive sheet, when pressure is applied to the pressure-sensitive adhesive layer, and also to increase in the bubble size gradually over time, leading to disappearance of the bubble-forming gas component. It may also leads to deterioration in adhesive properties and possibly to residual of the adhesive on the adherent.

The pressure-sensitive adhesive layer of the present invention preferably has a urethane resin or a styrene copolymer as its base polymer, but the resin is not limited thereto, and it may contain a urethane resin and a styrene copolymer together.

### (Bubbles)

The pressure-sensitive adhesive layer of the present invention contains bubbles as an essential component. The presence of the bubbles improves the elasticity and flexibility of the pressure-sensitive adhesive layer. For that reason, it leads to improvement of the impression (feeling) of use, for example, when the pressure-sensitive adhesive sheet of the present invention having the pressure-sensitive adhesive layer is used as the pressure-sensitive adhesive sheet for body warmer, and in particular when the pressure-sensitive adhesive sheet for body warmer is bonded (affixed) to the skin directly (direct adhesion). It also leads to improvement in adhesiveness to the adherent. Thus, it leads to improvement of the long-term adhesiveness of the pressure-sensitive adhesive sheet for body warmer (property of retaining adhesive strength without exfoliation for a long term), for example, when the pressure-sensitive adhesive sheet of the present invention is used as a pressure-sensitive adhesive sheet for body warmer. In addition, the properties above can be obtained at low cost. It is also easier to reduce the size of the foam structure, compared to the case where only the hollow microspheres are used, and thus, it is favorable when a thin pressure-sensitive adhesive sheet is formed.

The bubbles are desirably fundamentally closed cell bubbles, but may be a mixture of closed cell bubbles and open cell bubbles.

The bubble normally has a spherical shape, but may have an irregularly spherical shape. The average diameter of the bubbles is preferably 30 to 400 μm, more preferably 30 to 350 μm and still more preferably 50 to 200 μm. An average diameter of less than 30 μm may prohibit the advantageous effects of the presence of bubbles (improvement in elasticity, flexibility and adhesiveness). An average diameter of more than 400 μm may lead to easy release of the bubble-forming gas component from the pressure-sensitive adhesive layer.

The bubble-forming gas component (also referred to as “bubble-forming gas”) is not particularly limited, and various gas components including inert gases (such as nitrogen, carbon dioxide and argon), air and the like can be used. If reaction such as polymerization reaction is conducted after mixing with a bubble-forming gas, it is also important to use a bubble-forming gas that does not inhibit the reaction. The bubble-forming gas is preferably carbon dioxide or nitrogen, most preferable nitrogen, from the viewpoint of prevention of reaction inhibition.

The content of the bubbles in the pressure-sensitive adhesive layer of the present invention is preferably 20 percent by volume (vol %) or more (for example, 20 to 80 vol %), more preferably 40 to 60 vol %, with respect to the total volume (100 vol %) of the pressure-sensitive adhesive layer, for maximum use of the advantageous effects of the presence of bubbles and also for cost reduction. A bubble content of less than 20 vol % may prohibit the improvement in elasticity, flexibility and adhesion of the pressure-sensitive adhesive layer at low cost. The bubble content can be determined by measurement of the density of the pressure-sensitive adhesive layer. Specifically, for example, it is determined in the following manner: First, the density (a) of the pressure-sensitive adhesive layer of the present invention is measured. Then, a pressure-sensitive adhesive layer identical in composition with the pressure-sensitive adhesive layer of the present invention, except that no bubbles are contained (bubble-free pressure-sensitive adhesive layer) is formed, and the density (b) of the bubble-free pressure-sensitive adhesive layer is measured. The bubble content (vol %) is calculated from the densities (a) and (b) by the following Formula:

Bubble content (vol %)=100−[{Density (a)/Density (b)}×100]

### (Hollow Microspheres)

The pressure-sensitive adhesive layer of the present invention contains hollow microspheres as an essential component. The presence of the hollow microspheres leads to improvement in elasticity and flexibility of the pressure-sensitive adhesive layer. For that reason, it leads to improvement of the impression of use, for example, when the pressure-sensitive adhesive sheet of the present invention having the pressure-sensitive adhesive layer is used as the pressure-sensitive adhesive sheet for body warmer, and in particular when the pressure-sensitive adhesive sheet for body warmer is bonded (affixed) to the skin directly (direct adhesion). It also leads to improvement in adhesiveness to the adherent. Thus, it leads to improvement of the long-term adhesiveness of the pressure-sensitive adhesive sheet for body warmer (property of retaining adhesive strength without exfoliation for a long term), for example, when the pressure-sensitive adhesive sheet of the present invention is used as a pressure-sensitive adhesive sheet for body warmer. Because the gas component is enclosed in shell in the hollow microspheres, the gas component is not released out of the pressure-sensitive adhesive layer, even when pressure is applied to the pressure-sensitive adhesive layer. In addition, because the hollow microsphere retains its shape, the bubbles are also resistant to destruction (the entire pressure-sensitive adhesive layer becomes more resistant to destruction by pressurization because of the presence of the hollow microspheres). Thus, the foam structure of the pressure-sensitive adhesive layer is resistant to destruction and the layer retains its elasticity, flexibility and adhesiveness even under pressure. Thus for example, even when the pressure-sensitive adhesive sheet of the present invention is used as a pressure-sensitive adhesive sheet for body warmer for a long period of time (in particular, when used for a long period of time, as the sheet is pressurized), the favorable impression of use of the pressure-sensitive adhesive sheet is preserved. It also leads to improvement particularly in long-term adhesiveness.

The hollow microsphere may be a hollow inorganic or organic microsphere. Typical examples of the hollow inorganic microspheres in the hollow microspheres above include hollow balloons of glass such as hollow glass balloon; hollow balloons of metals such as hollow alumina balloons; hollow balloons of ceramics such as hollow ceramic balloons; and the like. Examples of the hollow organic microspheres include hollow balloons of resins such as hollow acrylic balloons and hollow vinylidene chloride balloons and the like. The hollow microspheres may be hollow microspheres prepared by expansion (foaming) of heat-expandable microspheres. These hollow microspheres may be used alone or in combination of two or more.

The particle diameter (average particle diameter) of the hollow microspheres is preferably, for example, 50 to 500 μm, more preferably 50 to 400 μm and still more preferably 50 to 300 μm. A particle diameter of less than 50 μm may prohibit the advantageous effects of the presence of hollow microspheres (improvement in elasticity, flexibility and adhesiveness and resistance to destruction by pressurization). A particle diameter of more than 500 μm may lead to deterioration in adhesiveness (tackiness) of the pressure-sensitive adhesive layer.

The density of the hollow microsphere is not particularly limited, but preferably, for example, 0.1 to 0.8 g/cm³, more preferably 0.12 to 0.5 g/cm³. A hollow microsphere density of less than 0.1 g/cm³ may prohibit the advantageous effects of the presence of hollow microspheres. A density of more than 0.8 g/cm³ may lead to deterioration in flexibility of the pressure-sensitive adhesive layer.

The content of the hollow microspheres in the pressure-sensitive adhesive layer of the present invention is not particularly limited, but preferably 1 to 20 parts by weight (wt parts), more preferably 3 to 10 wt parts, with respect to the total weight (100 wt parts) of the base polymer (urethane resin or styrene copolymer) forming the pressure-sensitive adhesive layer. A hollow microsphere content of less than 1 wt part may prohibit the advantageous effects of the presence of hollow microspheres. A hollow microsphere content of more than 20 wt parts may lead to disadvantage in cost and deterioration in adhesive power (adhesive strength) of the pressure-sensitive adhesive layer.

Commercial products can also be used as the hollow microspheres, and examples thereof include “Fuji Balloon” (trade name, manufactured by Fuji Silysia Chemical Ltd.); “CEL-STAR Z-25”, “Cel-star Z-27”, “Cel-star CZ-31T”, “Cel-star Z-36”, “Cel-star Z-39”, “Cel-star T-36”, “Cel-star SX-39” and “Cel-star PZ-6000” (trade names, manufactured by Tokai Kogyo Co., Ltd.); “Silux Fine Balloon” (trade name, manufactured by Fine Balloon Ltd.); “Matsumoto Microsphere MFL60CA” (trade name, manufactured by Matsumoto Yushi-Seiyaku Co., Ltd.) and the like.

As described above, the hollow microspheres in the pressure-sensitive adhesive layer of the present invention may be hollow microspheres prepared by expansion (foaming) of heat-expandable microspheres. Specifically, the pressure-sensitive adhesive layer containing the hollow microspheres can be prepared by blending heat-expandable microspheres to the composition for foaming the pressure-sensitive adhesive layer of the present invention (hereinafter, referred to as “pressure-sensitive adhesive layer-forming composition”), and expanding (foaming) the heat-expandable microspheres under heat. It is possible by using such heat-expandable microspheres to select the timing of foaming arbitrarily according to the user's desire and application, because the heat-expandable microspheres can be converted to hollow microspheres by expansion anytime before or after the pressure-sensitive adhesive layer-forming composition is processed into a sheet shape. The heat-expandable microspheres can be used alone or in combination of two or more.

The heat-expandable microsphere (also referred to as “heat-expandable foaming agent”) is for example a microsphere containing a substance that easily gasifies and expands under heat such as isobutane, propane or pentane in an elastic shell. The shell is often formed with a substance softening under heat. Examples of the shell-forming substances include vinylidene chloride-acrylonitrile copolymers, polyvinylalcohol, polyvinylbutyral, polymethyl methacrylate, polyacrylonitrile, polyvinylidene chloride, polysulfone and the like. The heat-expandable microspheres can be prepared by a common method, for example, such as coacervation method or interfacial polymerization method.

The particle diameter (average particle diameter) of the heat-expandable microspheres (before expansion) is not particularly limited, but should be smaller than the thickness of the pressure-sensitive adhesive layer, and is thus, preferably 10 to 150 μm, more preferably 10 to 50 μm. Because there is a need for reduction in density of the pressure-sensitive adhesive layer, preferable is use of heat-expandable microspheres having a suitable strength that are resistant to expansion until the volumetric expansion rate becomes twice or more, preferably 10 times or more.

The heat expansion-starting temperature of the heat-expandable microsphere is not particularly limited, but preferably, 70 to 200° C., more preferably 90 to 150° C. A heat expansion-starting temperature of lower than 70° C. may result in expansion (foaming) of most of the heat-expandable microspheres during application of the pressure-sensitive adhesive layer-forming composition. On the other hand, a heat expansion-starting temperature of higher than 200° C. may lead to degradation of the pressure-sensitive adhesive by the heat applied during expansion. The “heat expansion-starting temperature”, as used in the present invention, is the temperature of the heat-expandable microsphere beginning to expand when it is analyzed on a thermal analyzer (manufactured by SII-NanoTechnology INC, trade name: “TMA/SS6100”) by an expansion method (load: 19.6 N, probe: 3 mmφ).

Commercial products can also be used as the heat-expandable microspheres, examples thereof include “Matsumoto Microsphere F-30”, “Matsumoto Microsphere F-50”, “Matsumoto Microsphere F-50D” and “Matsumoto Microsphere F-85” (trade names, manufactured by Matsumoto Yushi-Seiyaku Co., Ltd.); “Expancel Du” (trade name, manufactured by Akzo Nobel Surface AB) and the like.

### (Surfactant)

The pressure-sensitive adhesive layer of the present invention may contain a surfactant, as needed. Examples of the surfactants include nonionic surfactants, ionic surfactant, amphoteric surfactant and the like. In particular, nonionic surfactants are particularly favorable.

Examples of the favorable nonionic surfactants include, but are not particularly limited to, fluorochemical surfactants, polyoxyethylene alkyl ethers, polyoxyethylene alkylphenyl ethers, polyoxyethylene lauryl ether, polyoxyethylene fatty acid esters, polyoxyethylene polyoxypropylene block polymers and the like. In particular, polyoxyethylene lauryl ether is particularly preferable.

The content (blending amount) of the surfactant in the pressure-sensitive adhesive layer of the present invention is preferably 1 to 5 wt parts, more preferably 1 to 3 wt parts, with respect to the total weight (100 wt parts) of the base polymer (urethane resin or styrene copolymer) forming the pressure-sensitive adhesive layer. A surfactant content of less than 1 wt part may prohibit the advantageous effects of the presence of the surfactant. A surfactant content of more than 5 wt parts may lead to significant deterioration in adhesiveness of the adhesive layer.

### (Tackifier Resin)

The pressure-Sensitive adhesive layer of the present invention may contain a tackifier resin (also called “tackifier”), as needed. Examples of the tackifier resins include, but are not particularly limited to, petroleum resins (aliphatic petroleum resins, aromatic petroleum resins, etc.), rosin resins, terpene resins, hydrogenated terpene resins, coumarone-indene resins and the like. These tackifier resins may be used alone or in combination of two or more. Among the resins above, terpene resins (terpene tackifier resins) and hydrogenated terpene resins (hydrogenated terpene tackifier resins) are particularly favorable, from the viewpoint of the resistance of the bubble forming gas being released from the pressure-sensitive adhesive layer.

Examples of the terpene tackifier resins and the hydrogenated terpene tackifier resins include terpene resins such as α-pinene polymer, β-pinene polymer and dipentene polymer; terpene resins modified from these terpene resins (for example, phenol-modified resins, aromatic-modified resins, hydrogenated resins, hydrocarbon-modified resins) such as terpene phenol resins, styrene-modified terpene resins, aromatic-modified terpene resins and hydrogenated terpene resins and the like. The term “terpene resin” or “terpene tackifier resin”, when used in the present description, means a terpene resin other than hydrogenated terpene resins (hydrogenated terpene tackifier resins).

The content (blending amount) of the tackifier resin in the pressure-sensitive adhesive layer of the present invention is preferably 0 to 400 wt parts, more preferably 20 to 100 wt parts and still more preferably 20 to 70 wt parts, with respect to 100 wt parts of the base polymer forming the pressure-sensitive adhesive layer. A tackifier resin content of more than 400 wt parts may lead to softening of the pressure-sensitive adhesive layer and thus, release of the bubble-forming gas from the pressure-sensitive adhesive layer (disappearance of bubbles from the pressure-sensitive adhesive layer) when pressure is applied to the pressure-sensitive adhesive layer.

Specifically, when the pressure-sensitive adhesive layer of the present invention is a urethane-based pressure-sensitive adhesive layer, the content of the terpene resin therein is preferably 0 to 60 wt parts, more preferably 0 to 20 wt parts, with respect to 100 wt parts of the urethane resin. A terpene resin content of more than 60 wt parts may lead to release of the bubble-forming gas from the pressure-sensitive adhesive layer. On the other hand, the content of the hydrogenated terpene resin is preferably 0 to 50 wt parts, more preferably 0 to 40 wt parts, with respect to 100 wt parts of the urethane resin. A hydrogenated terpene resin content of more than 50 wt parts may lead to release of the bubble-forming gas from the pressure-sensitive adhesive layer. The urethane-based pressure-sensitive adhesive layer of the present invention, in particular, is preferably a pressure-sensitive adhesive layer added with a terpene resin in an amount of 0 to 60 wt parts and a hydrogenated terpene resin in an amount of 0 to 50 wt parts, with respect to 100 wt parts of the urethane resin (in particular, UV-curing urethane resin).

When the pressure-sensitive adhesive layer of the present invention is a styrene-based pressure-sensitive adhesive layer, the content of the terpene resin therein is preferably 0 to 100 wt parts, more preferably 0 to 50 wt parts, with respect to 100 wt parts of the styrene copolymer. A terpene resin content of more than 100 wt parts may lead to release of the bubble-forming gas from the pressure-sensitive adhesive layer. On the other hand, the content of the hydrogenated terpene resin is preferably 0 to 400 wt parts, more preferably 0 to 50 wt parts, with respect to 100 wt parts of the styrene copolymer. A hydrogenated terpene resin content of more than 400 wt parts may lead to release of the bubble-forming gas from the pressure-sensitive adhesive layer. In particular, the styrene-based pressure-sensitive adhesive layer of the present invention is preferably a pressure-sensitive adhesive layer added with a terpene resin in an amount of 0 to 100 wt parts and a hydrogenated terpene resin in an amount of 0 to 400 wt parts, with respect to 100 wt parts of the styrene copolymer (in particular, SIS).

### (Other Components)

The pressure-sensitive adhesive layer of the present invention may contain, in addition to the essential components above (base polymer, hollow microspheres and bubbles), the surfactant and the tackifies resin, other suitable additives, as needed. Examples thereof include crosslinking agents (e.g., polyisocyanate crosslinking agents, silicone crosslinking agents, epoxy crosslinking agents, alkyletherified melamine crosslinking agents, etc.), plasticizers, fillers, aging inhibitors, colorants (pigments and dyes) and the like.

The density of the pressure-sensitive adhesive layer of the present invention is preferably 0.4 to 0.8 g/cm³, more preferably 0.5 to 0.6 g/cm³. A density of less than 0.4 g/cm³ may result in easier disappearance of the bubbles by pressurization. A density of more than 0.8 g/cm³ may result in insufficient foaming. The density can be determined, for example, by the following method. A test sample of a particular size (for example, length 100 mm×width 100 mm) is cut off from a pressure-sensitive adhesive sheet. The weight of the test sample is determined, and the weight of the pressure-sensitive adhesive layer is calculated by subtracting the weight of the base material from the weight of the test sample. Then, the thickness of the pressure-sensitive adhesive layer is measured under microscope, and the volume of the pressure-sensitive adhesive layer is calculated. Finally, the density of the pressure-sensitive adhesive layer is calculated from the weight and the volume of the pressure-sensitive adhesive layer obtained.

The density may be calculated by measurement of the weight and volume of the pressure-sensitive adhesive layer after a pressure-sensitive adhesive layer having a predetermined thickness is separated from the pressure-sensitive adhesive sheet.

The expansion ratio of the pressure-sensitive adhesive layer of the present invention is preferably L2 to 2.5 times, more preferably 1.4 to 2.3 times and still more preferably 1.5 to 2.0 times. An expansion ratio of less than 1.2 times may prohibit the advantageous effects of the presence of the foam structure (flexibility, elasticity and adhesiveness to adherent), while an expansion ratio of more than 2.5 times may lead to easier destruction of the foam structure in the pressure-sensitive adhesive layer by pressurization. The expansion ratio can be calculated from the density ratio between “the pressure-sensitive adhesive layer of the present invention” and “the pressure-sensitive adhesive layer without bubbles and hollow microspheres”. Specifically, it is calculated in the following manner: First, a pressure-sensitive adhesive layer (bubble-free and hollow microsphere-free pressure-sensitive adhesive layer: hereinafter, referred to as “non-expandable pressure-sensitive adhesive layer”) is formed by a method similar to that for the pressure-sensitive adhesive layer to be tested, by using a pressure-sensitive adhesive layer-forming composition identical in composition with the pressure-sensitive adhesive layer-forming composition for the pressure-sensitive adhesive layer to be tested (the pressure-sensitive adhesive layer of the present invention), except that no bubble and no hollow microspheres are added (mixed). Thus, the non-expandable pressure-sensitive adhesive layer is a pressure-sensitive adhesive layer identical with the pressure-sensitive adhesive layer to be tested, except that no bubbles or no hollow microspheres are contained. The densities of the pressure-sensitive adhesive layer to be tested and the non-expandable pressure-sensitive adhesive layer are determined by the density measurement method described above and the expansion ratio (times) is calculated according to the following Formula:

Expansion ratio (times)=(Density of non-expandable pressure-sensitive adhesive layer)/(Density of pressure-sensitive adhesive layer to be tested)

The pressure-sensitive adhesive layer of the present invention is preferably a hot-melt (heat-melt) pressure-sensitive adhesive layer that is prepared by fusion under heat. The hot-melt pressure-sensitive adhesive layer is advantageous from the environmental point, because it is prepared without use of solvent. When a nonwoven fabric is used as the base material, the pressure-sensitive adhesive layer may be formed by applying (coating) the pressure-sensitive adhesive layer-forming composition on the base material directly.

The thickness of the pressure-sensitive adhesive layer of the present invention is not particularly limited, but preferably 50 to 700 μm, more preferably 70 to 450 μm and still more preferably 70 to 200 μm. A thickness of less than 60 μm may lead to insufficient expression of the advantageous effects of the presence of the foam structure and deterioration in flexibility and adhesiveness of the pressure-sensitive adhesive layer. On the other hand, thickness of more than 700 μm may prohibit production of a uniform-thickness pressure-sensitive adhesive layer or lead to disadvantage from the economical point.

### [Release Liner (Separator)]

The pressure-sensitive adhesive sheet of the present invention may have a release liner on the adhesive face thereof for protection of the surface (adhesive face) of the pressure-sensitive adhesive layer before use: The release liner is separated before the adhesive face protected by the release liner is used (i.e., when the pressure-sensitive adhesive sheet is adhered to the adherent).

The release liner is not particularly limited, and common release liners (peel-away backings) can be used, and examples thereof for use include base materials having a release-treated layer, low adhesive base materials including a fluorochemical polymer, low adhesive base materials including a nonpolar polymer and the like. Examples of the base materials having a release-treated layer include plastic films and papers surface-treated with a release agent such as a silicone release agent, long-chain alkyl release agent or fluorochemical release agent or molybdenum sulfide release agent, and the like. Examples of the fluorochemical polymers in the low adhesive base materials including a fluorochemical polymer include polytetrafluoroethylene, polychloro-trifluoroethylene, polyvinyl fluoride, polyvinylidene fluoride, tetrafluoroethylene-hexafluoropropylene copolymers, chlorofluoroethylene-vinylidene fluoride copolymers and the like. Examples of the nonpolar polymers in the low adhesive base materials including a nonpolar polymer include polyolefin resins (e.g., polyethylene and polypropylene) and the like. The release liner can be prepared by a known and common method. The thickness of the release liner, for example, is also not particularly limited.

### [Method of Producing the Pressure-Sensitive Adhesive Sheet of the Present Invention]

The pressure-sensitive adhesive sheet of the present invention can be obtained by forming the pressure-sensitive adhesive layer of the present invention on at lease one side of the base material (e.g., a plastic base material such as plastic film or porous film or a fibrous base material such as nonwoven fabric).

The method of forming the pressure-sensitive adhesive layer is not particularly limited, but a method by hot-melt coating (heat-melt coating) is preferable. Specifically, the pressure-sensitive adhesive layer can be formed by coating a pressure-sensitive adhesive layer-forming composition [composition containing a mixture of a base polymer or a prepolymer for the base polymer, hollow microspheres or heat-expandable microspheres, bubbles, and tackifier resins, surfactants and other various additives added as needed] on the base material, after the composition is melted under heat. In addition to the hot-melt coating step, the method of forming the pressure-sensitive adhesive layer may contain, as needed, a step of obtaining hollow microspheres by expansion (foaming) of heat-expandable microspheres or a step of obtaining a base polymer by polymerization of the prepolymer. The hot-melt coating, which does not use solvent, is advantageous from the environmental point and also advantageous in that direct coating is possible thereby even on a nonwoven fabric base material.

The pressure-sensitive adhesive layer-forming composition is obtained by mixing a base polymer (or a prepolymer of the base polymer), hollow microspheres (or heat-expandable microspheres), bubbles and tackifier resins, surfactants and other various additives added as needed. The mixing method is not particularly limited, but, for example, a method of mixing the hot-melted base polymer (or prepolymer of the base polymer) with other components [hollow microspheres (or heat-expandable microspheres), bubbles and tackifier resins, surfactants and other various additives] is preferable. The temperature during mixing (mixing temperature) is not particularly limited, but preferably 60 to 200° C., more preferably 80 to 120° C. The mixing apparatus is not particularly limited, and examples thereof include pressurized kneader and the like.

When the hollow microspheres are prepared by expansion (foaming) of heat-expandable microsphere in the method of producing the pressure-sensitive adhesive sheet of the present invention, the heat-expandable microspheres are expanded by heating. The heating can be performed, for example, in an applicator or on a plate. The heating temperature is not particularly limited, as it varies according to the heat expansion-starting temperature of the heat-expandable microspheres, but preferably 70 to 160° C., more preferably 90 to 130° C. The heating period is not particularly limited, but preferably 1 minute to 10 minutes, more preferably 3 minutes to 5 minutes.

The order of the step of heat-expanding the heat-expandable microspheres in the production process for the pressure-sensitive adhesive sheet of the present invention (production process for the pressure-sensitive adhesive layer) is not particularly limited, but the step is preferably carried out after the base polymer (or prepolymer for the base polymer), the heat-expandable microspheres, the bubbles, and the tackifier resins, the surfactants and other various additives as needed are mixed. It may be before the coated film (coated layer, pressure-sensitive adhesive layer-forming composition layer) is formed or after the coated film is formed by hot-melt coating of a pressure-sensitive adhesive layer-forming composition on a base material.

The coating amount of the pressure-sensitive adhesive layer forming composition during hot-melt coating is preferably 50 to 300 g/m², more preferably 70 to 150 g/m². A coating amount of less than 50 g/m² may lead to decrease of the ratio of the coating thickness to the bubble size and thus defoaming at the die area during coating, resulting in insufficient expansion ratio and deterioration in elasticity, flexibility and adhesiveness to the adherent. A coating amount of more than 300 g/m² may lead to easier disintegration (destruction) of the foam structure of the pressure-sensitive adhesive layer by pressurization. The heating temperature during hot-melt coating is not particularly limited, as it varies according to the kind of the base polymer used and the kind of the composition coated, but preferably 60 to 200° C., more preferably 80 to 150° C. The coating machine used during coating is not particularly limited, as it varies according to the shape of the pressure-sensitive adhesive layer, and coating machines commonly used may be used. Examples thereof include gravure roll coaters, reverse roll coaters, kiss roll coaters, dip roll coaters, bar coaters, knife coaters, spray coaters, die coaters and the like. In particular, coating by the die coater method of using a super foam head is preferable for prevention of build-up and improvement of foaming efficiency.

Hereinafter, typical examples of the methods of producing a pressure-sensitive adhesive sheet of the present invention having a urethane-based pressure-sensitive adhesive layer (in particular, urethane-based pressure-sensitive adhesive layer containing an active energy ray-curing urethane resin) and a pressure-sensitive adhesive sheet of the present invention having a styrene-based pressure-sensitive adhesive layer (in particular, styrene-based pressure-sensitive adhesive layer containing SIS) will be described. However, the present invention is not limited thereto.

### (Method of Producing the Pressure-Sensitive Adhesive Sheet of the Present Invention Having a Urethane-Based Pressure-Sensitive Adhesive Layer)

The pressure-sensitive adhesive sheet of the present invention having a urethane-based pressure-sensitive adhesive layer can be prepared, for example, by the following production method. A pressure-sensitive adhesive layer-forming composition is prepared as a urethane prepolymer, and heat-expandable microspheres are mixed, and then, a bubble-forming gas is mixed with the mixture obtained. The pressure-sensitive adhesive layer-forming composition is then coated on a base material, forming a layer (coated film) of the pressure-sensitive adhesive layer-forming composition on the base material; active energy ray (particularly preferably ultraviolet ray) is irradiated on the coated film, for polymerization of the urethane prepolymer; the heat-expandable microspheres are then expanded into hollow microspheres, forming a pressure-sensitive adhesive layer of the present invention and thus a pressure-sensitive adhesive sheet of the present invention. The step of expanding the heat-expandable microspheres may be located before the coated film is formed.

In the step of mixing the urethane prepolymer and the heat-expandable microspheres, it is preferable to add and mix a photopolymerization initiator, in addition to the urethane prepolymer and the heat-expandable microspheres. It is also possible to add and mix tackifier resins, surfactants and other various additives, as needed. The urethane prepolymer above is a prepolymer for urethane resin and preferably, for example, a urethane prepolymer having an active energy ray-polymerizable (photopolymerizable) functional group, such as the urethane prepolymer having a reactive functional group described above. Examples of the photopolymerization initiators for use include those described above as the photopolymerization initiator for the urethane resin. The mixing is preferably carried out under heat at a temperature of about 70 to 120° C. (in particular, 80 to 110° C.), for optimization of the fluidity of the urethane prepolymer.

Then, a bubble-forming gas is mixed with the mixture obtained in the step above (mixture of a urethane prepolymer, heat-expandable microspheres and others). Obtained in this way is a bubble-containing composition (pressure-sensitive adhesive layer-forming composition). Examples of the apparatuses for mixing the bubble-forming gas include FM coating machine manufactured by Nordson K.K. and the like.

The pressure-sensitive adhesive layer-forming composition obtained in the step above is then coated on a base material, forming a layer (coated film) of the pressure-sensitive adhesive layer-forming composition on the base material. The coating amount of the pressure-sensitive adhesive layer-forming composition is preferably 50 to 300 g/m², more preferably 70 to 150 g/m². The coating temperature (temperature of the pressure-sensitive adhesive layer-forming composition during coating) is preferably 60 to 140° C., more preferably 80 to 120° C.

In addition, active energy ray is irradiated to the coated film on the base material obtained in the step above, for polymerization of the urethane prepolymer in the coated film. Obtained in this way is a coated film (coated film after irradiation with active energy ray) containing a urethane resin and heat-expandable microspheres. The active energy ray is not particularly limited, and examples thereof include ionizing radiation rays such as α ray, β rays, γ ray, neutron beam and electron beam, ultraviolet ray and the like, and ultraviolet ray is particularly favorable.

Finally, the heat-expandable microspheres in the coated film (coated film after irradiation with active energy ray) obtained in the step above are expanded into hollow microspheres under heat, to give a pressure-sensitive adhesive sheet of the present invention having a urethane-based pressure-sensitive adhesive layer. The heating temperature during the heating expansion is preferably 70 to 160° C., more preferably 90 to 130° C. The heating period is preferably 1 minute to 10 minutes, more preferably 3 minutes to 5 minutes.

(Method of Producing the Pressure-Sensitive Adhesive Sheet of the Present invention Having a Styrene-Based Pressure-Sensitive Adhesive Layer)

The pressure-sensitive adhesive sheet of the present invention having a styrene-based pressure-sensitive adhesive layer can be prepared, for example, by the following production method. A pressure-sensitive adhesive layer-forming composition is prepared, as a styrene copolymer (in particular, SIS copolymer) and heat-expandable microspheres are mixed, and a bubble-forming gas is mixed with the mixture obtained. The pressure-sensitive adhesive layer-forming composition is then coated on a base material, forming a layer (coated film) of the pressure-sensitive adhesive layer-forming composition on the base material, and the heat-expandable microspheres are expanded into hollow microspheres, forming a pressure-sensitive adhesive layer of the present invention and thus, a pressure-sensitive adhesive sheet of the present invention. The step of expanding the heat-expandable microspheres may be located before the coated film is formed.

In the step of mixing the styrene copolymer with heat-expandable microspheres, in addition to the styrene copolymer and the heat-expandable microspheres, tackifier resins, surfactants and other various additives may be added, as needed. The mixing is preferably carried out under heat at a temperature about 100 to 200° C. (in particular, 120 to 160° C.) for optimization of the fluidity of the styrene copolymer.

A bubble-forming gas is then mixed with the mixture (mixture containing the styrene copolymer, the heat-expandable microspheres and others) obtained in the step above, to give a bubble-containing composition (pressure-sensitive adhesive layer-forming composition). Examples of the apparatuses for mixing the bubble-forming gas include FM coating machine manufactured by Nordson K.K. and the like.

The pressure-sensitive adhesive layer-forming composition obtained in the step above is coated on a base material, forming a layer (coated film) of the pressure-sensitive adhesive layer-forming composition on the base material. The coating amount of the pressure-sensitive adhesive layer-forming composition is preferably 50 to 300 g/m², more preferably 70 to 200 g/m². The coating temperature (temperature of the pressure-sensitive adhesive layer-forming composition during coating) is preferably 80 to 190° C., more preferably 120 to 170° C.

Finally, the heat-expandable microspheres in the coated film obtained in the step above are expanded into hollow microspheres under heat, to give a pressure-sensitive adhesive sheet of the present invention having a styrene-based pressure-sensitive adhesive layer. The heating temperature during the heating expansion is preferably 70 to 160° C., more preferably 90 to 130° C. The heating period is preferably 1 minute to 10 minutes, more preferably 3 minutes to 5 minutes.

### [Disposable Body Warmer]

It is possible to produce a disposable body warmer (disposable body warmer of the present invention), by using the pressure-sensitive adhesive sheet of the present invention as a pressure-sensitive adhesive sheet for the body warmer. Thus, the disposable body warmer of the present invention is a disposable body warmer containing the pressure-sensitive adhesive sheet of the present invention (pressure-sensitive adhesive sheet for body warmer) as a constituent member [preferably, constituent member for a bag for storing a heating unit (bag-constituting component, bag-constituting member)]. Specifically, it is possible to prepare a disposable body warmer of the present invention, for example, by using the pressure-sensitive adhesive sheet of the present invention as a bag-constituting component [preferably, bag-constituting component to the side bonded (affixed) to the adherent (backing material, rear member)], heat-sealing the pressure-sensitive adhesive sheet of the present invention with a bag-constituting component other than the bag-constituting component of the pressure-sensitive adhesive sheet of the present invention (facing material, front member) to form a bag, and enclosing a heating unit in the bag. In the present description, the “bag-constituting component other than the bag-constituting component of the pressure-sensitive adhesive sheet of the present invention” may be referred to as “other bag-constituting component”.

The disposable body warmer of the present invention has a bag and a heating unit enclosed in the bag. The bag has, for example, a pressure-sensitive adhesive sheet for body warmer of the present invention (backing material) and another bag-constituting component (facing material). FIG. 2 is a schematic cross-sectional view showing an example of the disposable body warmer of the present invention. The disposable body warmer according to the present invention 2 shown in FIG. 2 has a bag formed by heat-sealing a pressure-sensitive adhesive sheet 1 of the present invention (pressure-sensitive adhesive sheet for body warmer) with another bag-constituting component 22, and a heating unit 21 enclosed in the bag.

### (Heating Unit)

The heating unit (exothermic material) enclosed in the bag is not particularly limited, and a heating unit such as that used in conventional disposable body warmers can be used, and examples thereof for use include metal powders such as iron powder, activated carbon, water, water-holding substances (wood powder, vermiculite, diatomaceous earth, pearlite, silica gel, alumina, water absorption resins etc.), sodium chloride and the like.

### (Other Bag-Constituting Component)

The other bag-constituting component (bag-constituting component other than the bag-constituting component of the pressure-sensitive adhesive sheet of the present invention) is not particularly limited, but preferably an air-permeable material, from the viewpoints of air permeability and efficiency of supplying oxygen to the heating unit. It is, for example, a laminated film of a porous film and an air-permeable material such as nonwoven fabric. The specific method of laminating the porous film with the air-permeable material is not particularly limited but, for example, it is preferably prepared by coating an adhesive on an air-permeable material and bonding a porous film on it.

The adhesive above is not particularly limited, and examples thereof for use include known adhesives such as rubber adhesives (e.g., natural rubbers, styrenic elastomers), urethane adhesives (acrylic urethane adhesives), and acrylic adhesives, silicone adhesives, polyester adhesives, polyamide adhesives, epoxy adhesives, vinyl alkylether adhesives and fluorochemical adhesives. The adhesives can be used alone or in combination of two or more.

The porous film is not particularly limited, if it is a film-shaped porous base material containing a polyolefin, polyester, polystyrene or other resin and may have a single-layer structure or a multilayer structure consisting of a single member or different members.

Among the resins above, the resin for the porous film for use is preferably a polyolefin resin, from the viewpoints of cost, flexibility and heat sealability. Specifically, the porous film is preferably a polyolefin porous film (olefinic porous film) containing a polyolefin resin. It is more preferably a polyethylene porous film (ethylenic porous film). The polyolefin resin is not particularly limited, if it is a resin containing at least an olefin component (e.g., α-olefin such as ethylene, propylene, butene-1, pentene-1, hexene-1,4-methyl-pentene-1, heptene-1 or octene-1) as the monomer component. These olefin components may be used alone or in combination of two or more.

Examples of the polyolefin resins include polyethylene resins such as low-density polyethylenes, linear low-density polyethylenes, medium-density polyethylenes, high-density polyethylenes, ethylene-vinyl acetate copolymers and ethylene-α-olefin copolymers (for example, ethylene-propylene copolymers); polypropylene resins (e.g., polypropylenes and propylene-α-olefin copolymers); polybutene resins (e.g., polybutene-1); poly-4-methylpentene-1 and the like. Examples of the polyolefin resins for use include ethylene-unsaturated carboxylic acid copolymers such as ethylene-acrylic acid copolymers and ethylene methacrylic acid copolymers; ionomers; ethylene-(meth)acrylic ester copolymers such as ethylene-methyl acrylate copolymers, ethylene-ethyl acrylate copolymers, and ethylene-methyl methacrylate copolymers; ethylene-vinylalcohol copolymers and the like. Of the polyolefin resins, polyethylene resins are preferred, and in particular, low-density polyethylenes, linear low-density polyethylenes and ethylene-α-olefin copolymers are preferred.

For carrying out heat sealing at a lower temperature and at a higher speed, it is effective to use heat-sealable resins having lower melting points. Among such resins, low-density polyethylenes prepared by using metallocene catalysts are effective.

The porous film may be an unoriented film or a film uniaxially or biaxially oriented, but preferably a uniaxially or biaxially oriented film. The porous film may contain an inorganic filler for providing the film with masking property and for making the film porous with voids (pores) generated when the film is stretched. Examples of the inorganic fillers include inorganic particles (inorganic fine particles) such as of titanium oxide and calcium carbonate and the like. The porous film may contain various other additives such as colorants, aging inhibitors, antioxidants, ultraviolet absorbents, flame retardants, stabilizers and others additionally in the ranges that do not impair the advantageous effects of the present invention.

The thickness of the porous film is not particularly limited, but it is, for example, about 10 to 500 μm, preferably 12 to 200 μm and more preferably 20 to 160 μm. The porous film may be processed additionally, as needed, by various treatments such as rear-face treatment and antistatic treatment.

The porous film can be prepared by a known and commonly used method for production of porous film such as melted film forming method (T die method or inflation method). In particular, T die method is preferable. For example, the porous film is manufactured by kneading the polyolefin resin, the inorganic filler and, as needed, various additives in a biaxial kneader into pellets, preparing an undrawn film by melt-extruding the pellets through a uniaxial extruder, and stretching the undrawn film uniaxially or biaxially. If the porous film is desirably laminated into a laminate film, co-extrusion method is used favorably.

The air-permeable material is not particularly limited and, examples thereof include a fiber material (e.g., nonwoven fabric) or the like. In particular, a nonwoven fabric is preferable. Any one of known commonly used nonwoven fabrics (nonwoven fabrics of natural and synthetic fibers) such as nylon nonwoven fabrics, polyester nonwoven fabrics, polyolefin nonwoven fabrics and rayon nonwoven fabrics may be used as the nonwoven fabric. The production method for the nonwoven fabric is also not particularly limited, and it may be, for example, a nonwoven fabric prepared by spunbonding (spunbond nonwoven fabric) or a nonwoven fabric prepared by spunlacing (spunlace nonwoven fabric). The nonwoven fabric may have a single-layer or multilayer structure. The fiber diameter, the fiber length, the basis weight and others of the nonwoven fabric are not particularly limited, but, for example, a nonwoven fabric having a basis weight of about 20 to 150 g/m² is preferable from the viewpoints of processability and cost. The nonwoven fabric may contain fibers of one type alone or contain fibers of two or more types in combination.

### (External Bag)

The disposable body warmer of the present invention is sold as the body warmer product being enclosed in an external bag (outer pouch). The base material for the external bag (base material for external bag) is not particularly limited, and may be, for example, a plastic base material, a fibrous base material (nonwoven fabric or woven fabric base material of various fibers), a metallic base material (metal foil base material of various metal components) or the like. A plastic base material can be used favorably as the base material. Examples of the plastic base materials include polyolefin base materials (e.g., polypropylene base materials and polyethylene base materials), polyester base materials (e.g., polyethylene terephthalate base materials), styrenic base materials (e.g., polystyrene base materials and acrylonitrile-butadiene-styrene copolymer base materials), amide resin base materials, acrylic resin base materials and the like. The base material for external bag may have a single-layer structure or may be a laminated film. The thickness of the external bag is not particularly limited, but preferably, for example 30 to 300 μm.

The external bag preferably has a layer (gas-barrier layer) having a property (gas barrier property) to prohibit permeation of a gas component such as oxygen gas or steam. Examples of the gas-barrier layers include, but are not particularly limited to, oxygen-barrier resin layers (e.g., layers made from polyvinylidene chloride resins, ethylene-vinylalcohol copolymers, polyvinylalcohol and polyamide resins), steam-barrier resin layers (e.g., layers made from polyolefin resins and polyvinylidene chloride resins), oxygen- and steam-barrier inorganic compound layers (e.g., layers made from metals (simple substances) such as aluminum and metal compounds including metal oxides such as silicon oxide and aluminum oxide) and the like. The gas-barrier layer may be a single layer (e.g., it may be the base material for external bag itself) or a laminated layer.

### EXAMPLES

Hereinafter, the present invention will be described more in detail with reference to Examples, but it should be understood that the present invention is not restricted by these Examples.

### Example 1

An aromatic modified terpene resin [trade name: “YS Resin TO-L”, manufactured by Yasuhara Chemical Co., Ltd.] (30 wt parts), an aromatic modified hydrogenated terpene resin [trade name: “Clearon K4090”, manufactured by Yasuhara Chemical Co., Ltd.] (20 wt parts), and heat-expandable microspheres [trade name: “Matsumoto Microsphere F-50D”, manufactured by Matsumoto Yushi-Seiyaku Co., Ltd.] (3 wt parts) were added to and mixed with a urethane prepolymer [trade name: “LIGHT TACK PSA-7511”, manufactured by Kyoeisha Chemical Co., Ltd.] (100 wt parts). Nitrogen (100 parts by volume (vol parts)) was then mixed with the mixture obtained (100 vol parts), to give a bubble-containing composition.

Then, the bubble-containing composition was applied (coated) on one side of a PET substrate (PET base material) [trade name: “FE2001”, manufactured by Futamura Chemical Co., Ltd., 38 μm] to a coating amount of 150 g/m² at approximately 80° C., to give a coated film of the bubble-containing composition.

The processings from preparation of the bubble-containing composition to formation of the coated film were carried out in a coating machine.

Ultraviolet ray was then irradiated onto the coated film for curing in a UV irradiation apparatus [manufactured by Fusion UV Systems JAPAN K.K.] under a condition of 240 W/cm. A separator is then bonded (affixed) to the coated film (after UV curing) and the composite was wound around a roll and heated at a temperature of 110° C. for expansion (foaming) of the heat-expandable microspheres, to give a pressure-sensitive adhesive sheet of the present invention (PET substrate).

A pressure-sensitive adhesive sheet of the present invention (nonwoven fabric base material) was prepared in a manner similar to that above, except that the PET substrate was replaced with a nonwoven fabric laminated with a porous film [trade name: “ZS0025”, manufactured by Toyobo Co., Ltd., 170 μm]. The pressure-sensitive adhesive layer was formed on the nonwoven fabric side of the nonwoven fabric laminated with a porous film.

A “pressure-sensitive adhesive sheet (PET substrate)” means a “pressure-sensitive adhesive sheet having a PET substrate” and a “pressure-sensitive adhesive sheet (nonwoven fabric base material)” means a “pressure-sensitive adhesive sheet having a nonwoven fabric base material”. A “pressure-sensitive adhesive sheet of the present invention (PET substrate)” means a “pressure-sensitive adhesive sheet of the present invention having a PET substrate” and a “pressure-sensitive adhesive sheet of the present invention (nonwoven fabric base material)” means a “pressure-sensitive adhesive sheet of the present invention having a nonwoven fabric base material”.

### Example 2

An aromatic modified terpene resin [trade name: “YS Resin TO-L”, manufactured by Yasuhara Chemical Co., Ltd.] (40 wt parts), an aromatic modified hydrogenated terpene resin [trade name: “Clearon K4090”, manufactured by Yasuhara Chemical Co., Ltd.] (20 wt parts), an ether-based nonionic surfactant [trade name: “Emulgen 104P”, manufactured by Kao Corporation] (3 wt parts) and microballoons (non-heat-expandable hollow microspheres) [trade name: “Matsumoto Microsphere MFL60CA”, manufactured by Matsumoto Yushi-Seiyaku Co., Ltd.] (3 wt parts) were added to and mixed with a urethane prepolymer [trade name: “LIGHT TACK PSA-7511”, manufactured by Kyoeisha Chemical Co., Ltd.] (100 wt parts). Nitrogen (100 vol parts) was then mixed with the mixture obtained (100 vol parts), to give a bubble-containing composition.

A pressure-sensitive adhesive sheet of the present invention (PET substrate) and a pressure-sensitive adhesive sheet of the present invention (nonwoven fabric base material) were prepared in a manner similar to Example 1, except that the bubble-containing composition above was used.

In Example 2 and Comparative Examples 1 and 3 to 6, the step of expanding the heat-expandable microspheres at a temperature of 110° C. was eliminated.

### Example 3

An aromatic modified terpene resin [trade name: “YS Resin TO-L”, manufactured by Yasuhara Chemical Co., Ltd.] (40 wt parts), an aromatic modified hydrogenated terpene resin [trade name: “Clearon K4090”, manufactured by Yasuhara Chemical Co., Ltd.] (20 wt parts), an ether-based nonionic surfactant [trade name: “Emulgen 104P”, manufactured by Kao Corporation] (3 wt parts) and heat-expandable microspheres [trade name: “Matsumoto Microsphere F-50D”, manufactured by Matsumoto Yushi-Seiyaku Co., Ltd.] (3 wt parts) were added to and mixed with a urethane prepolymer [trade name: “LIGHT TACK PSA-7511” manufactured by Kyoeisha Chemical Co., Ltd.] (100 wt parts). Nitrogen (100 vol parts) was then mixed with the mixture obtained (100 vol parts), to give a bubble-containing composition.

A pressure-sensitive adhesive sheet of the present invention (PET substrate) and a pressure-sensitive adhesive sheet of the present invention (nonwoven fabric base material) were prepared in a manner similar to Example 1, except that the bubble-containing composition above was used.

### Example 4

An aromatic modified terpene resin [trade name: “YS Resin TO-L”, manufactured by Yasuhara Chemical Co., Ltd.] (25 wt parts) and heat-expandable microspheres [trade name: “Matsumoto Microsphere F-50D”, manufactured by Matsumoto Yushi-Seiyaku Co., Ltd.] (3 wt parts) were added to and mixed with a urethane prepolymer [trade name: “LIGHT TACK PSA-7511”, manufactured by Kyoeisha Chemical Co., Ltd.] (100 wt parts). Nitrogen (100 vol parts) was then mixed with the mixture obtained (100 vol parts), to give a bubble-containing composition.

Then, the bubble-containing composition was applied (coated) on one side of a PET substrate [trade name: “FE2001”, manufactured by Futamura Chemical Co., Ltd., 38 μm] to a coating amount of 100 g/m² at approximately 80° C., to give a coated film of the bubble-containing composition.

Ultraviolet ray was then irradiated onto the coated film for curing in a UV irradiation apparatus [manufactured by Fusion UV Systems JAPAN K.K.] under a condition of 240 W/cm. A separator is then bonded (affixed) to the coated film (after UV curing) and the composite was wound around a roll and heated at a temperature of 110° C. for expansion (foaming) of the heat-expandable microspheres, to give a pressure-sensitive adhesive sheet of the present invention (PET substrate).

A pressure-sensitive adhesive sheet of the present invention (nonwoven fabric base material) was prepared in a manner similar to that above, except that the PET substrate was replaced with a nonwoven fabric laminated with a porous film [trade name: “ZS0025”, manufactured by Toyobo Co., Ltd., 170 μm]. The pressure-sensitive adhesive layer was formed on the nonwoven fabric side of the nonwoven fabric laminated with a porous film.

### Example 5

An aromatic modified hydrogenated terpene resin [trade name: “Clearon K4090”, manufactured by Yasuhara Chemical Co., Ltd.] (25 wt parts), and heat-expandable microspheres [trade name: “Matsumoto Microsphere F-50D”, manufactured by Matsumoto Yushi-Seiyaku Co., Ltd.] (3 wt parts) were added to and mixed with a urethane prepolymer [trade name: “LIGHT TACK PSA-7511”, manufactured by Kyoeisha Chemical Co., Ltd.] (100 wt parts). Nitrogen (100 vol parts) was then mixed with the mixture obtained (100 vol parts), to give a bubble-containing composition.

A pressure-sensitive adhesive sheet of the present invention (PET substrate) and a pressure-sensitive adhesive sheet of the present invention (nonwoven fabric base material) were prepared in a manner similar to Example 4, except that the bubble-containing composition above was used.

### Example 6

An aromatic modified terpene resin [trade name: “YS Resin TO-L”, manufactured by Yasuhara Chemical Co., Ltd.] (70 wt parts), an aromatic modified hydrogenated terpene resin [trade name: “Clearon K4090”, manufactured by Yasuhara Chemical Co., Ltd.] (300 wt parts) and heat-expandable microspheres [trade name: “Matsumoto Microsphere F-50D”, manufactured by Matsumoto Yushi-Seiyaku Co., Ltd.] (3 wt parts) were added to and mixed with a SIS copolymer [trade name: “Quintac 3433N”, manufactured by Zeon Corporation] (100 wt parts). Nitrogen (100 vol parts) was then mixed with the mixture obtained (100 vol parts), to give a bubble-containing composition.

The bubble-containing composition was then applied (coated) on one side of a PET substrate [trade name: “FE2001”, manufactured by Futamura Chemical Co., Ltd., 38 μm] to a coating amount of 100 g/m² at approximately 100° C., to give a coated film of the bubble-containing composition.

A separator is then bonded (affixed) to the coated film and the composite was wound around a roll and heated at a temperature of 110° C. for expansion (foaming) of the heat-expandable microspheres, to give a pressure-sensitive adhesive sheet of the present invention (PET substrate).

A pressure-sensitive adhesive sheet of the present invention (nonwoven fabric base material) was prepared in a manner similar to that above, except that the PET substrate was replaced with a nonwoven fabric laminated with a porous film [trade name: “ZS0025”, manufactured by Toyobo Co., Ltd. 170 μm]. The pressure-sensitive adhesive layer was formed on the nonwoven fabric side of the nonwoven fabric laminated with a porous film.

### Comparative Example 1

An aromatic modified terpene resin [trade name: “YS Resin TO-L”, manufactured by Yasuhara Chemical Co., Ltd.] (30 wt parts) and an aromatic modified hydrogenated terpene resin [trade name: “Clearon K4090”, manufactured by Yasuhara Chemical Co., Ltd.] (20 wt parts) were added to and mixed with a urethane prepolymer [trade name: “LIGHT TACK PSA-7511”, manufactured by Kyoeisha Chemical Co., Ltd.] (100 wt parts). Nitrogen (100 vol parts) was then mixed with the mixture obtained (100 vol parts), to give a bubble-containing composition.

A pressure-sensitive adhesive sheet (PET substrate) and a pressure-sensitive adhesive sheet (nonwoven fabric base material) were prepared in a manner similar to Example 1, except that the bubble-containing composition above was used.

### Comparative Example 2

An aromatic modified terpene resin [trade name: “YS Resin TO-L”, manufactured by Yasuhara Chemical Co., Ltd.] (35 wt parts), an aromatic modified hydrogenated terpene resin [trade name: “Clearon K4090”, manufactured by Yasuhara. Chemical Co., Ltd.] (10 wt parts) and heat-expandable microspheres [trade name: “Matsumoto Microsphere F-50D”, manufactured by Matsumoto Yushi-Seiyaku Co., Ltd.] (3 wt parts) were added to and mixed with a urethane prepolymer [trade name: “LIGHT TACK PSA-7511”, manufactured by Kyoeisha Chemical Co., Ltd.] (100 wt parts), to give a mixture.

A pressure-sensitive adhesive sheet (PET substrate) and a pressure-sensitive adhesive sheet (nonwoven fabric base material) were prepared in a manner similar to Example 1, except that the bubble-containing composition was replaced with the mixture above.

### Comparative Example 3

An aromatic modified terpene resin [trade name: “YS Resin TO-L”, manufactured by Yasuhara Chemical Co., Ltd.] (30 wt parts) and an aromatic modified hydrogenated terpene resin [trade name: “Clearon K4090”, manufactured by Yasuhara Chemical Co., Ltd.] (20 wt parts) were mixed with a urethane prepolymer [trade name: “LIGHT TACK PSA-7511”, manufactured by Kyoeisha Chemical Co., Ltd.] (100 wt parts), to give a mixture.

A pressure-sensitive adhesive sheet (PET substrate) and a pressure-sensitive adhesive sheet (nonwoven fabric base material) were prepared in a manner similar to Example 1, except that the bubble-containing composition was replaced with the mixture above.

### Comparative Example 4

An aromatic modified terpene resin [trade name: “YS Resin TO-L”, manufactured by Yasuhara Chemical Co., Ltd.] (70 wt parts), an aromatic modified hydrogenated terpene resin [trade name: “Clearon K4090”, manufactured by Yasuhara Chemical Co., Ltd.] (300 wt parts) were mixed with a SIS copolymer [trade name: “Quintac 3433N”, manufactured by Zeon Corporation] (100 wt parts), to give a mixture.

A pressure-sensitive adhesive sheet (PET substrate) and a pressure-sensitive adhesive sheet (nonwoven fabric base material) were prepared in a manner similar to Example 6, except that the bubble-containing composition was replaced with the mixture above.

### Comparative Example 5

A pressure-sensitive adhesive sheet (PET substrate) and a pressure-sensitive adhesive sheet (nonwoven fabric base material) were prepared in a manner similar to Example 4, except that no heat-expandable microsphere was added and no nitrogen was mixed.

### Comparative Example 6

A pressure-sensitive adhesive sheet (PET substrate) and a pressure-sensitive adhesive sheet (nonwoven fabric base material) were prepared in a manner similar to Example 5, except that no heat-expandable microsphere was added and no nitrogen was mixed.

### (Evaluation)

The pressure-sensitive adhesive sheets obtained in Examples and Comparative Examples above were evaluated by the following evaluation methods. Evaluation results are summarized in Table 1.

### (1) Thickness and Density of Pressure-Sensitive Adhesive Layer and Expansion Ratio

### (Thickness of Pressure-Sensitive Adhesive Layer)

Pressure-sensitive adhesive sheets of PET substrate, among the pressure-sensitive adhesive sheets obtained in Examples and Comparative Examples, were used for measurement. Each of the pressure-sensitive adhesive sheets (PET substrate) obtained in Examples and Comparative Examples was cut to a test piece (sample) having a dimension of length 100 mm×width 100 mm.

The test piece was observed horizontally (in the width direction) under digital microscope, and the total thickness of the test piece [sum of the thickness of base material (PET substrate) and thickness of pressure-sensitive adhesive layer] was determined. The separator was removed from the test piece before observation under digital microscope.

In addition, the thickness of the base material (PET substrate) without the pressure-sensitive adhesive layer was also determined similarly and the thickness of the pressure-sensitive adhesive layer was calculated from the thicknesses of the base material and the total thickness.

### (Density of Pressure-Sensitive Adhesive Layer)

Subsequently, the weight of the test piece [total weight of the base material (PET substrate) and the pressure-sensitive adhesive layer] was determined on a tabletop electronic balance. The weight of the base material without the pressure-sensitive adhesive layer (PET substrate: length 100 mm×width 100 mm) was determined additionally on the tabletop electronic balance, and the weight of the pressure-sensitive adhesive layer was calculated from the weights of the test piece and the base material.

The density of the pressure-sensitive adhesive layer is calculated from the sample size (test piece size), the thickness of the pressure-sensitive adhesive layer and the weight of the pressure-sensitive adhesive layer calculated above.

### (Expansion Ratio of Pressure-Sensitive Adhesive Layer)

The expansion ratio of the pressure-sensitive adhesive layer in each of the samples (test pieces) of Examples 1 to 6 and Comparative Examples 1 and 2 was calculated, according to the calculation formula described above:

[Expansion ratio (times)=(Density of non-expandable pressure-sensitive adhesive layer)/(Density of pressure-sensitive adhesive layer to be tested)].

The pressure-sensitive adhesive layer of Comparative Example 3 corresponds to the non-expandable pressure-sensitive adhesive layers of Example 1 and Comparative Example 1; the pressure-sensitive adhesive layer of Comparative Example 4 corresponds to the non-expandable pressure-sensitive adhesive layer of Example 6; the pressure-sensitive adhesive layer of Comparative Example 5 corresponds to the non-expandable pressure-sensitive adhesive layer of Example 4; and the pressure-sensitive adhesive layer of Comparative Example 6 corresponds to the non-expandable pressure-sensitive adhesive layer of Example 5.

In other words, the density of the pressure-sensitive adhesive layer of Comparative Example 3 is used as the density of non-expandable pressure-sensitive adhesive layer, in calculation of the expansion ratios of pressure-sensitive adhesive layer in Example 1 and Comparative Example 1. The density of the pressure-sensitive adhesive layer of Comparative Example 4 is used as the density of non-expandable pressure-sensitive adhesive layer, in calculation of the expansion ratio of pressure-sensitive adhesive layer in Example 6. The density of the pressure-sensitive adhesive layer of Comparative Example 5 is used as the density of non-expandable pressure-sensitive adhesive layer, in calculation of the expansion ratio of pressure-sensitive adhesive layer in Example 4. The density of the pressure-sensitive adhesive layer of Comparative Example 6 is used as the density of non-expandable pressure-sensitive adhesive layer, in calculation of the expansion ratio of pressure-sensitive adhesive layer in Example 5.

In the cases of Examples 2 and 3 and Comparative Example 2, a pressure-sensitive adhesive sheet (PET substrate) having a non-expandable pressure-sensitive adhesive layer corresponding to the pressure-sensitive adhesive layer was prepared, and the density of the non-expandable pressure-sensitive adhesive layer was determined similarly. The pressure-sensitive adhesive sheets were prepared in a corresponding manner similar to Examples 2 and 3 and Comparative Example 2, except that no heat-expandable microsphere was added and no nitrogen was mixed. The density of the non-expandable pressure-sensitive adhesive layer corresponding to the pressure-sensitive adhesive layer of Example 2 (the density of non-expandable pressure-sensitive adhesive layer used in calculation of the expansion ratio of pressure-sensitive adhesive layer in Example 2) was 0.99 g/cm³; the density of the non-expandable pressure-sensitive adhesive layer corresponding to the pressure-sensitive adhesive layer of Example 3 (the density of non-expandable pressure-sensitive adhesive layer used in calculation of the expansion ratio of pressure-sensitive adhesive layer in Example 3) was 0.97 g/cm³; and the density of the non-expandable pressure-sensitive adhesive layer corresponding to the pressure-sensitive adhesive layer of Comparative Example 2 (the density of non-expandable pressure-sensitive adhesive layer used in calculation of the expansion ratio of pressure-sensitive adhesive layer in Comparative Example 2) was 0.99 g/cm³.

### (2) Adhesive Power (Adhesive Strength) to SUS Plate

Pressure-sensitive adhesive sheets of PET substrate, among the pressure-sensitive adhesive sheets obtained in Examples and Comparative Examples, were used for measurement. A strip-shaped sheet (strip of sheet) of length 100 mm×width 10 mm was cut off from each of the pressure-sensitive adhesive sheets (PET substrate) obtained in Examples and Comparative Examples.

After the separator is removed from the strip-shaped sheet, a stainless steel (SUS) plate (SUS 304BA plate, thickness: 15 mm) was bonded (affixed) onto the pressure-sensitive adhesive layer-sided surface of the sheet by one reciprocation under a 2 kg rubber roller (width: approximately 45 mm), to give a sample. The sample was left under an atmosphere at 23° C. and 40% relative humidity (RH) for 30 minutes and then subjected to the 180 degree)(180°) peel test according to Japanese Industrial Standards (JIS) Z0237 by using a tensile tester (trade name: “Tension”, manufactured by Orientec Co., Ltd.) at a tensile speed of 300 mm/minute, and the 180° peel strength (180° peel adhesion) to stainless steel plate (N/10 mm) was determined as the “adhesive power to SUS plate”. The test number (n) was 3.

### (3) Adhesive Power to the Skin

Pressure-sensitive adhesive sheets of nonwoven fabric base material, among the pressure-sensitive adhesive sheets obtained in Examples and Comparative Examples, were used for measurement. Each of the pressure-sensitive adhesive sheets (nonwoven fabric base material) obtained in Examples and Comparative Examples was cut into a test sample having a size of length 100 mm×width 10 mm.

Right after adhesion of the test sample to the skin, the adhesive power (180° peel strength to the skin) was determined by using a push-pull gauge (trade name: “CPU Gauge MODEL-9500”, manufactured by Aikoh Engineering Co., Ltd.) under the condition of a tensile speed of 300 mm/minute and a peel angle of 180°, and used as the “adhesive power to the skin”. Measurement was carried out in an environment at 23° C. and 40% RH.

### (4) Repetition Adhesive Power

Pressure-sensitive adhesive sheets of nonwoven fabric base material, among the pressure-sensitive adhesive sheets obtained in Examples and Comparative Examples, were used for measurement. Each of the pressure-sensitive adhesive sheets (nonwoven fabric base material) obtained in Examples and Comparative Examples was cut into a test sample having a size of length 100 mm×width 10 mm.

Right after adhesion of the test sample to the skin, the adhesive power (180° peel strength to the skin) (N/10 mm) was determined by using a push-pull gauge (trade name: “CPU gauge MODEL-9500”, manufactured by Aikoh Engineering Co., Ltd.) under the condition of a tensile speed of 300 mm/minute and a peel angle of 180°. Measurement was carried out in an environment at 23° C. and 40% RH.

The operation above (adhesion, 180° peeling and adhesive power measurement) was repeated five times by using the same test sample. The repetition adhesive power (%) to the skin was calculated from the “adhesive power (to the skin) during the 5th peeling” and the “adhesive power during the first peeling” (adhesive power to the skin) according to the following Formula:

Repetition adhesive power (%)=(Adhesive power during 5th peeling)/(Adhesive power during 1st peeling)×100

### (5) Long-Term Adhesiveness to the Skin

Pressure-sensitive adhesive sheets of nonwoven fabric base material, among the pressure-sensitive adhesive sheets obtained in Examples and Comparative Examples, were used for measurement. Each of the pressure-sensitive adhesive sheets (nonwoven fabric base material) obtained in Examples and Comparative Examples was cut into a test sample having a size of length 50 mm×width 10 mm.

Right after adhesion of the test sample to the skin, a load of 5 gf was applied vertically (in a direction perpendicular to an affixing face of the test sample) to the terminal in the length direction of the test sample and the period until the test sample is removed completely was measured with a stopwatch. Measurement was carried out in an environment at 23° C. and 40% RH.

The test sample was bonded (affixed) to the skin with the skin facing down and the test sample bonded from below. The load was applied by a clipped weight hanging from one terminal in the length direction of the test sample.

The test sample was bonded (affixed) to the inner region of the arm between elbow and wrist (inner forearm) in the direction along the line from elbow to wrist. The site of the test sample bonded (affixed) is the same in the evaluations of (3), (4) and (6).

### (6) Cuticle Removal Rate

Pressure-sensitive adhesive sheets of nonwoven fabric base material, among the pressure-sensitive adhesive sheets obtained in Examples and Comparative Examples, were used for measurement. Each of the pressure-sensitive adhesive sheets (nonwoven fabric base material) obtained in Examples and Comparative Examples was cut into a test sample having a size of length 50 mm×width 50 mm.

After adhesion of the test sample to the skin and storage in an environment at 23° C. and 40% RH for 30 minutes, the test sample was peeled off by using a push-pull gauge at a tensile speed of 300 mm/minute and a peel angle of 180°.

Then, a stain solution [liquid mixture containing Brilliant Green (manufactured by Wako Pure Chemical Industries, Ltd.), Crystal Violet (manufactured by Wako Pure Chemical Industries, Ltd.) and water at a ratio of 0.5:1:98.5 (by weight)] was added dropwise on the pressure-sensitive adhesive layer-sided surface of the test sample peeled off. After storage for 30 minutes under an environment at 23° C. and 40% RH, the test sample was washed (as the test sample, as held with tweezers, was immersed in water and shaken horizontally therein) and dried, and then, the pressure-sensitive adhesive layer surface (entire surface) was observed under digital microscope, the ratio of the area stained to the entire surface of the pressure-sensitive adhesive layer was determined as cuticle removal rate (%).

### (7) Foam Change Test

Pressure-sensitive adhesive sheets of PET substrate, among the pressure-sensitive adhesive sheets obtained in Examples and Comparative Examples, were used for measurement. Each of the pressure-sensitive adhesive sheets (PET substrate) obtained in Examples and Comparative Examples was cut into a test sample having a size of length 50 mm×width 50 mm.

The test sample was held between two sheets of drawing paper and stored in an environment at 50° C., as a load of 1.2 kgf was applied thereon, for 45 hours.

The thickness of pressure-sensitive adhesive layer before and after the storage was determined, and the ratio of the thickness of pressure-sensitive adhesive layer after storage for 45 hours to the thickness of pressure-sensitive adhesive layer before storage [(thickness of pressure-sensitive adhesive layer after storage for 45 hours)/(thickness of pressure-sensitive adhesive layer before storage)×100] (%) was determined.

The thickness of pressure-sensitive adhesive layer was measured similarly to the Evaluation test (1) described above.

### (8) Total Thickness Change Test

Pressure-sensitive adhesive sheets of PET substrate, among the pressure-sensitive adhesive sheets obtained in Examples and Comparative Examples, were used for measurement. Each of the pressure-sensitive adhesive sheets (PET substrate) obtained in Examples and Comparative Examples was cut into a test sample having a size of length 100 mm×width 25 mm.

A nonwoven fabric (trade name: “ZS0025”, manufactured by Toyobo Co., Ltd., size: 100 mm×25 mm) was placed on the surface of the pressure-sensitive adhesive layer of the test sample and heat-sealed thereon under the condition of a temperature of 110° C., a pressure of 4 kgf/cm², a period of 0.5 second, and a heat-seal width of 25 mm.

The total thickness of the PET substrate, pressure-sensitive adhesive layer and nonwoven fabric was determined before and after heat sealing (heat seal), and the change in the total thickness of the PET substrate, pressure-sensitive adhesive layer and nonwoven fabric before and after heat sealing (μm): [(total thickness before heat seal)-(total thickness after heat seal)] was determined.

Similarly to evaluation (1), the total thickness of the laminated film of test sample and a nonwoven fabric (laminated film of PET substrate, pressure-sensitive adhesive layer and nonwoven fabric) was determined horizontally (in the width direction) by observation under digital microscope.

### (9) Impression of Use

Pressure-sensitive adhesive sheets of nonwoven fabric base material, among the pressure-sensitive adhesive sheets obtained in Examples and Comparative Examples, were used for measurement. Each of the pressure-sensitive adhesive sheets (nonwoven fabric base material) obtained in Examples and Comparative Examples was cut into a test sample having a size of length 50 mm×width 25 mm.

The test sample was bonded (affixed) to the skin in the region of the arm from elbow to wrist and left as it was for 1 hour. 10 testers examined the impression of use according to the following criteria, and the number of the testers who judged that the impression of use was unfavorable was determined.

Favorable impression of use: The pressure-sensitive adhesive sheet feels soft and flexible. In addition, the pressure-sensitive adhesive sheet can be separated smoothly.

Unfavorable impression of use: The pressure-sensitive adhesive sheet feels hard or irritating to the skin or was separated less easily.

TABLE 1

| | | | | | | | | Comparative |
|---|---|---|---|---|---|---|---|---|
| | | Example 1 | Example 2 | Example 3 | Example 4 | Example 5 | Example 6 | Example 1 |
| Coating amount | (g/m²) | 150 | 150 | 150 | 100 | 100 | 100 | 150 |
| Thickness of | (μm) | 315 | 305 | 305 | 163 | 171 | 185 | 298 |
| pressure-sensitive adhesive layer | | | | | | | | |
| Density of | (g/m³) | 0.58 | 0.52 | 0.54 | 0.70 | 0.70 | 0.61 | 0.64 |
| pressure-sensitive adhesive layer | | | | | | | | |
| Expansion ratio | (times) | 1.7 | 1.9 | 1.8 | 1.4 | 1.4 | 1.6 | 1.5 |
| Adhesive power to SUS plate | (N/10 mm) | 4.0 | 2.5 | 2.3 | 3.6 | 3.8 | 5.4 | 4.3 |
| Adhesive power to the skin | (N/10 mm) | 1.5 | 1.3 | 1.3 | 0.5 | 1.1 | 1.7 | 1.6 |
| Repetition adhesive power | (%) | 68 | 60 | 62 | 61 | 56 | 60 | 61 |
| Long-term adhesiveness to the skin | (sec) | 242 | 201 | 196 | 159 | 123 | 136 | 255 |
| Cuticle removal rate | (%) | 21 | 29 | 24 | 36 | 42 | 42 | 39 |
| Foam change test | (%) | 92 | 90 | 91 | 94 | 95 | 90 | 71 |
| [(Thickness of pressure-sensitive adhesive | | | | | | | | |
| layer after storage for 45 hours)/ | | | | | | | | |
| (Thickness of pressure-sensitive adhesive | | | | | | | | |
| layer before storage) × 100] | | | | | | | | |
| Total thickness change test | (μm) | 3 | 10 | 8 | 5 | 7 | 20 | 20 |
| [(Total thickness before heat seal) − | | | | | | | | |
| (Total thickness after heat seal)] | | | | | | | | |
| Impression of use | (out of 10 persons) | 0 | 0 | 0 | 0 | 1 | 1 | 1 |

| | | Comparative | Comparative | Comparative | Comparative | Comparative |
|---|---|---|---|---|---|---|
| | | Example 2 | Example 3 | Example 4 | Example 5 | Example 6 |
| Coating amount | (g/m²) | 150 | 150 | 100 | 100 | 100 |
| Thickness of | (μm) | 289 | 158 | 104 | 92 | 94 |
| pressure-sensitive adhesive layer | | | | | | |
| Density of | (g/m³) | 0.76 | 0.98 | 0.97 | 0.98 | 0.98 |
| pressure-sensitive adhesive layer | | | | | | |
| Expansion ratio | (times) | 1.3 | 1.0 | 1.0 | 1.0 | 1.0 |
| Adhesive power to SUS plate | (N/10 mm) | 3.3 | 4.4 | 6.8 | 2.7 | 4.3 |
| Adhesive power to the skin | (N/10 mm) | 0.8 | 0.7 | 1.2 | 0.4 | 0.6 |
| Repetition adhesive power | (%) | 52 | 43 | 41 | 55 | 49 |
| Long-term adhesiveness to the skin | (sec) | 103 | 78 | 99 | 90 | 68 |
| Cuticle removal rate | (%) | 49 | 89 | 88 | 80 | 88 |
| Foam change test | (%) | 99 | — | — | — | — |
| [(Thickness of pressure-sensitive adhesive | | | | | | |
| layer after storage for 45 hours)/ | | | | | | |
| (Thickness of pressure-sensitive adhesive | | | | | | |
| layer before storage) × 100] | | | | | | |
| Total thickness change test | (μm) | 4 | 10 | 62 | 8 | 13 |
| [(Total thickness before heat seal) − | | | | | | |
| (Total thickness after heat seal)] | | | | | | |
| Impression of use | (out of 10 persons) | 1 | 5 | 5 | 3 | 4 |

The results in Table 1 show the followings: The pressure-sensitive adhesive sheets of the present invention having a pressure-sensitive adhesive layer containing bubbles and hollow microspheres (Examples 1 to 6) are superior in impression of use (favorable impression of use, small cuticle removal) and adhesiveness (adhesive power to SUS plate, adhesive power to the skin, repetition adhesive power and long-term adhesiveness to the skin). In addition, the change in thickness of the pressure-sensitive adhesive layer is small, even after long-term storage under load in the foam change test, and the foam structure is resistant to destruction even under pressure. Further, the change in total thickness between before and after heat sealing in the total thickness change test is smaller, and impregnation into nonwoven fabric occurs less easily. The thickness of pressure-sensitive adhesive layer per coating amount is higher and thus, it is possible to form a thick pressure-sensitive adhesive layer with a smaller pressure-sensitive adhesive amount. For that reason, they are also favorable from the point of cost.

Alternatively when hollow microspheres are not contained in the pressure-sensitive adhesive layer (Comparative Example 1), the thickness of pressure-sensitive adhesive layer declines significantly and the foam structure of the pressure-sensitive adhesive layer is destructed easily when stored under load for a long period in the foam change test. The change in total thickness between before and after heat sealing in the total thickness change test is also larger and the pressure-sensitive adhesive layer easily impregnates into the nonwoven fabric during heat sealing. On the other hand, when no bubble is contained in the pressure-sensitive adhesive layer (Comparative Example 2), the thickness of pressure-sensitive adhesive layer per coating amount becomes smaller, which is disadvantageous from the point of cost. In addition, when no bubble and no hollow microsphere is contained in the pressure-sensitive adhesive layer (Comparative Examples 3 to 6), the pressure-sensitive adhesive sheets are inferior in the impression of use and adhesiveness, and the pressure-sensitive adhesive layer impregnates easily into the nonwoven fabric during heat sealing.

### [Reference Signs List]

Pressure-sensitive adhesive sheet
   11 Pressure-sensitive adhesive layer (pressure-sensitive adhesive layer of the present invention)
   12 Base material
   13 Release liner (separator)
   14 Bubble
   15 Hollow microsphere
2 Disposable body warmer
   21 Heating unit
   22 Other bag-constituting component

1. A pressure-sensitive adhesive sheet, comprising:
a base material; and
a pressure-sensitive adhesive layer containing a urethane resin or a styrene copolymer and also containing hollow microspheres and bubbles, formed at least on one side of the base material.

2. The pressure-sensitive adhesive sheet according to claim 1, the pressure-sensitive adhesive sheet being a pressure-sensitive adhesive sheet for body warmer.

3. The pressure-sensitive adhesive sheet according to claim 1, wherein the hollow microspheres are hollow microspheres formed by expansion of heat-expandable microspheres.

4. A disposable body warmer, comprising the pressure-sensitive adhesive sheet according to claim 2 as a bag-constituting component.

5. The pressure-sensitive adhesive sheet according to claim 2, wherein the hollow microspheres are hollow microspheres formed by expansion of heat-expandable microspheres.
